(19) United States
(12) Patent Application Publication
(10) Pub. No.: US 2026/0346678 A1
(43) Pub. Date: Nov. 5, 2026

(54) ROOF-MOUNTED AIR CONDITIONER AND VEHICLE

(71) Applicant: GD MIDEA AIR-CONDITIONING EQUIPMENT CO., LTD., Foshan (CN)

(72) Inventors: Yinyin ZHANG, Foshan (CN); Anping LIU, Foshan (CN); Hejie ZHOU, Foshan (CN); Fashen LIU, Foshan (CN); Qing TAO, Foshan (CN); Zhicai CAI, Foshan (CN)

(21) Appl. No.: 19/124,793

(22) PCT Filed: Nov. 30, 2022
(86) PCT No.: PCT/CN2022/135535

§ 371 Date: Apr. 25, 2025

(30) Foreign Application Priority Data
Nov. 18, 2022 (CN) 202211446455.7
Nov. 18, 2022 (CN) 202223091716.6

(51) Int. Cl. B60H 1/00; B60H 1/32

(52) U.S. Cl. CPC B60H 1/00364; B60H 1/00535; B60H 1/3233

(57) ABSTRACT

A roof-mounted air conditioner includes a chassis with an indoor air inlet and an indoor air outlet provided at a front portion thereof and a water collection groove provided at a rear portion thereof, an indoor heat exchanger fixedly connected to the chassis and located between the indoor air inlet and the indoor air outlet, and a drain pan arranged between the chassis and a bottom of the indoor heat exchanger. A drainage groove is arranged on the chassis, and the drainage groove is in communication with the drain pan and the water collection groove.

### CROSS-REFERENCE TO RELATED APPLICATIONS

This application claims priority to Chinese Patent Application No. 202211446455.7, filed on Nov. 18, 2022 and entitled “Roof-mounted air conditioner and vehicle” and Chinese Patent Application No. 202223091716.6, filed on Nov. 18, 2022 and entitled “Roof-mounted air conditioner and vehicle,” the entire contents of both of which are incorporated herein by reference.

### FIELD

The present disclosure relates to the technical field of air conditioning equipment, and in particular to a roof-mounted air conditioner and a vehicle.

### BACKGROUND

In the related art, a roof-mounted air conditioner is generally mounted on the roof of a vehicle. As such, the drainage system of the roof-mounted air conditioner is likely to cause condensed water to drop from a mounting opening on the vehicle roof since it may fail to fully consider the drainage and collection of condensed water. The water leaking problem will affect the user's experience.

### SUMMARY

The present disclosure aims to resolve at least one of the problems in the related art. To this end, the present disclosure provides a roof-mounted air conditioner, which has a more reasonable design and can effectively solve the problem of condensed water entering the vehicle through the mounting opening on the vehicle roof.

The present disclosure further provides a vehicle including the roof-mounted air conditioner.

In accordance with a first aspect of the present disclosure, an embodiment provides a roof-mounted air conditioner, which is arranged to be mounted at a mounting opening on the roof of a vehicle. The roof-mounted air conditioner includes a chassis, an indoor heat exchanger, and a drain pan. An indoor air inlet and an indoor air outlet are provided within a front portion of the chassis, and a rear portion of the chassis is provided with a water collection groove. The indoor heat exchanger is fixedly connected to the chassis and is located between the indoor air inlet and the indoor air outlet. The drain pan is arranged between the chassis and a bottom of the indoor heat exchanger. The chassis is provided with a first drainage groove, and the first drainage groove is in communication with the drain pan and the water collection groove.

In accordance with a second aspect of the present disclosure, an embodiment provides a vehicle, including a roof, where a mounting opening is provided on the roof, and the roof-mounted air conditioner in accordance with the embodiments of the first aspect is mounted in the mounting opening.

The roof-mounted air conditioner of the embodiments of the present disclosure at least has the following advantages.

The indoor air inlet and the indoor air outlet of the chassis are in communication with the interior of the vehicle through the mounting opening on the roof of the vehicle, such that indoor air may exchange heat with the indoor heat exchanger. The drain pan is used to collect condensed water generated by the indoor heat exchanger. Water in the drain pan is discharged to the water collection groove through the first drainage groove, in this way the condensed water from the indoor air inlet or the indoor air outlet may be prevented from dropping through the mounting opening of the vehicle roof. This solution can effectively solve the problem of condensed water entering the vehicle through the mounting opening, improve user experience, and allow the roof-mounted air conditioner to be used in a vehicle such as a recreational vehicle.

Additional features and advantages of the disclosure will be set forth in the following description, and in part will be obvious from the description, or may be learned by the practice of the disclosure.

### BRIEF DESCRIPTION OF DRAWINGS

FIG. 1 is a schematic structural view of a roof-mounted air conditioner assembled to a roof of a vehicle according to an embodiment of the present disclosure;

FIG. 2 is a schematic structural view of a roof-mounted air conditioner without a top cover according to an embodiment of the present disclosure;

FIG. 3 is a schematic sectional view taken along line A-A in FIG. 2;

FIG. 4 is a schematic structural view of a roof-mounted air conditioner without an upper component and an inner air duct fixation member according to an embodiment of the present disclosure;

FIG. 5 is a schematic sectional view taken along line B-B in FIG. 4;

FIG. 6 is a schematic structural enlarged view of part a in FIG. 5;

FIG. 7 is a schematic sectional view taken along line C-C in FIG. 4;

FIG. 8 is a schematic sectional view taken along line D-D in FIG. 4;

FIG. 9 is a schematic sectional view taken along line E-E in FIG. 4;

FIG. 10 is a schematic structural enlarged view of part b in FIG. 9;

FIG. 11 is a schematic structural view of a chassis according to an embodiment of the present disclosure;

FIG. 12 is a schematic structural bottom view of a chassis according to an embodiment of the present disclosure;

FIG. 13 is a schematic structural front view of a chassis according to an embodiment of the present disclosure; and

FIG. 14 is a schematic sectional view taken along line F-F in FIG. 13.

List of reference numerals as followings:
chassis 100; indoor air inlet 110; indoor air outlet 120; first drainage groove 130; inclined surface 131; narrowed opening 132; water collection groove 140; inclined guide surface 141; temperature-controlled drain valve 142; temperature-controlled drain port 143; second drainage groove 150; first side wall 151; second side wall 152; drainage hole 153; protrusion rib 154; overflow gap 155; stop rib 160; first stop rib 161; second stop rib 162; rear plate 170; notch 171; rear baffle wall 172; front baffle wall 180; front left baffle wall 181; front middle baffle wall 182; front right baffle wall 183; third drainage groove 190;
top cover 200; air intake grille 210;
inner air duct assembly 300; indoor heat exchanger 301; evaporator 310; air duct component 320; upper component 321; lower component 322; inner air duct fixation member 330; inner fan 340; inner motor 341; cross-flow impeller 342; drain pan 350; water outlet 351; first end face 352; second end face 353; groove 354;
outer air duct assembly 400; outdoor heat exchanger 401; condenser 410; outer air duct fixation member 420; outer fan 430; outer motor 431; impeller 432;
electronic control box assembly 500
compressor 600;
support plate 700; opening 710;
sealing ring 800;
damping strip 900;
roof-mounted air conditioner 1000;
roof 2000; mounting opening 2100.

### DETAILED DESCRIPTION OF EMBODIMENTS

Embodiments of the present disclosure will be described in detail hereinafter in conjunction with accompanying drawings in which the same or like reference numerals refer to the same or like elements or elements having the same or like functions throughout. The embodiments described below by reference to the accompanying drawings are exemplary and are intended for illustration only and are not to be construed as limiting the present disclosure.

In the description of the present disclosure, it should be understood that orientation or position relationships indicated by the terms such as front, rear, up, down, left and right are based on orientation or position relationships shown in the accompanying drawings, and are used only for ease and brevity of illustration and description, rather than indicating or implying that the mentioned apparatus or component need to have a particular orientation or need to be constructed and operated in a particular orientation. Therefore, such terms should not be construed as limiting of the present disclosure.

In the description of the present disclosure, the terms such as first, second and the like used herein are merely used for distinguishing technical features, and are not intended to indicate or imply relative importance, or implicitly point out the number of the indicated technical features, or implicitly point out the order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

The technical schemes adopted in the present disclosure will be described clearly and fully in conjunction with the accompanying drawings. Apparently, the embodiments described are merely part of the embodiments of the present disclosure, not all of the embodiments.

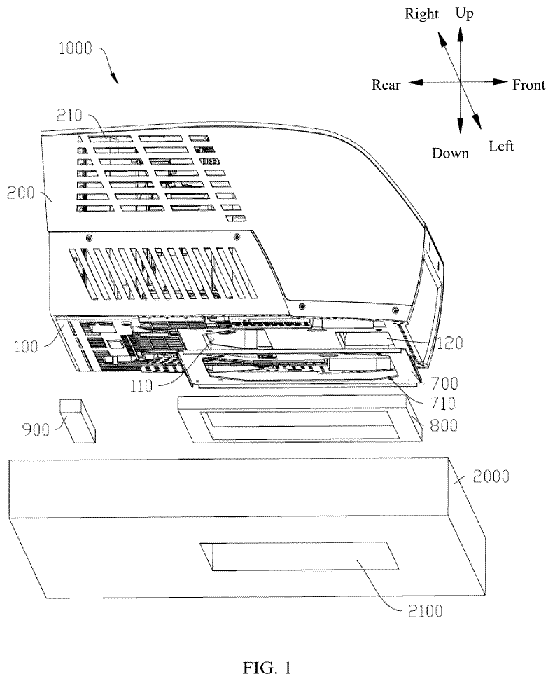

Referring to FIG. 1, a roof-mounted air conditioner 1000 according to an embodiment of the present disclosure includes a chassis 100 and a top cover 200. The top cover 200 is connected to the chassis 100. An indoor air inlet 110 and an indoor air outlet 120 are provided at a bottom of the chassis 100. Air intake grilles 210 are respectively provided on both sides of the chassis 100 and the top cover 200 to form an outdoor air inlet. An air exhaust grille is provided on a rear side of the top cover 200 and the chassis 100 to form an outdoor air outlet.

It may be understood that, using a recreational vehicle as an example, the roof-mounted air conditioner 1000 is mounted on a roof 2000 of the recreational vehicle. The roof 2000 of the recreational vehicle is provided with a mounting opening 2100, and both the indoor air inlet 110 and the indoor air outlet 120 face downward and are in communication with the mounting opening 2100, to achieve air circulation with the air in the vehicle. Outside the roof-mounted air conditioner 1000, air flows in from the outdoor air inlet on two sides and flows out from the outdoor air outlet on the rear side, to achieve air flow on the outdoor side.

The orientations in the embodiments of the present disclosure, such as front and rear, left and right, or, up and down, are based on the chassis 100, and are described with reference to the orientation relationships indicated in FIG. 1. The front, rear, left, right, up and down directions of the roof-mounted air conditioner 1000 are related to and correspond one-to-one to those of the recreational vehicle. In addition, in an embodiment, a length direction of the chassis 100 is a front-rear direction, a width direction of the chassis 100 is a left-right direction, and a height direction of the chassis 100 is an up-down direction.

Referring to FIG. 1, in an embodiment, a support plate 700 and a sealing ring 800 are arranged at a bottom of the chassis 100. The support plate 700 is provided with an opening 710 corresponding to the mounting opening 2100. When the roof-mounted air conditioner 1000 is mounted on the roof 2000 of the recreational vehicle, the support plate 700 is fixedly connected to the roof 2000, and the opening 710 is in communication with the mounting opening 2100. The roof-mounted air conditioner 1000 is mounted on the support plate 700, and the sealing ring 800 is arranged between the support plate 700 and the roof 2000 to provide an effective sealing effect. In this way, the indoor air inlet 110 and the indoor air outlet 120 are in communication with an interior of the recreational vehicle through the mounting opening 2100. In addition, a damping strip 900 is further provided between a rear portion of the chassis 100 and the roof 2000. The damping strip 900 may provide a buffering effect, to reduce the shaking of the roof-mounted air conditioner 1000 caused by the bumpy driving and improve the mounting stability. It should be noted that a front portion of the chassis 100 faces the front side of the recreational vehicle, and the rear portion of the chassis 100 faces the rear side of the recreational vehicle.

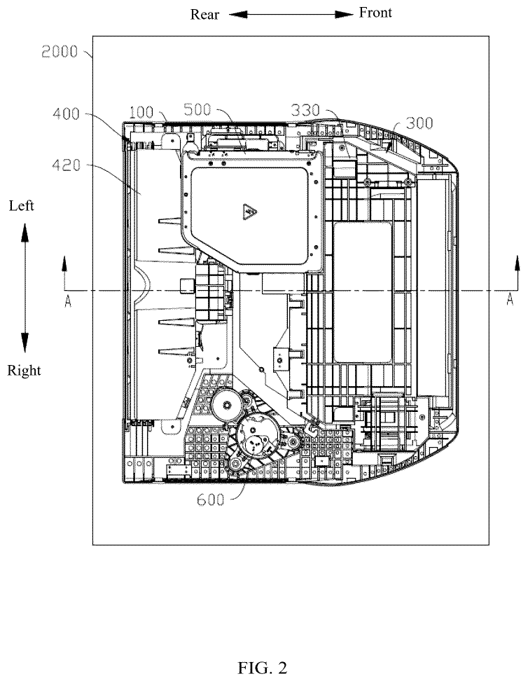

FIG. 2 is a structural assembled view of the roof-mounted air conditioner 1000 without a top cover 200. It may be understood that the roof-mounted air conditioner 1000 further includes an inner air duct assembly 300 and an outer air duct assembly 400. The inner air duct assembly 300 is mounted at the front portion of the chassis 100. The outer air duct assembly 400 is mounted at the rear portion of the chassis 100. A certain space is formed between the inner air duct assembly 300 and the outer air duct assembly 400, and the space works as an air inlet channel of the outer air duct assembly 400. An electronic control box assembly 500 is mounted on the top of the air inlet channel. The electronic control box assembly 500 is erected between the inner air duct assembly 300 and the outer air duct assembly 400. The electronic control box assembly 500 is electrically connected to components, including a compressor 600, an inner fan 340, and an outer fan 430 through wires. The electronic control box assembly 500 is mounted on a side close to the chassis 100. The compressor 600 is mounted on a side of the chassis 100 away from the electronic control box assembly 500. The compressor 600 is fixedly connected to the chassis 100.

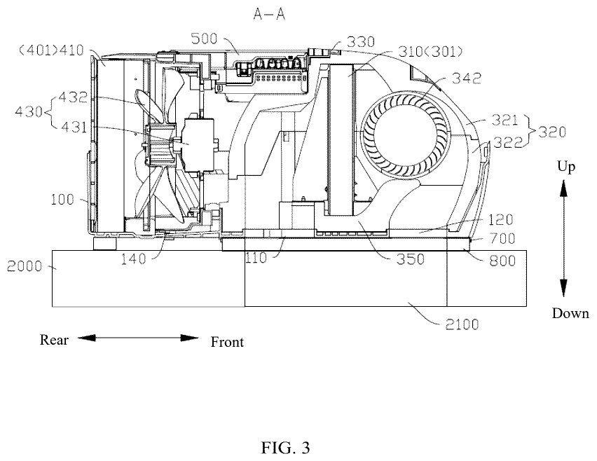

Referring to FIG. 2 and FIG. 3, it may be understood that the inner air duct assembly 300 includes an indoor heat exchanger 301, an inner fan 340, and an air duct component 320. An inner air duct fixation member 330 is provided on a top of the air duct component 320. The air duct component 320 is fixed to the chassis 100 through the inner air duct fixation member 330. The internal air duct component 320 may include an upper component 321 and a lower component 322. An indoor air duct is defined by the upper component 321 and the lower component 322. The indoor air duct is in communication with the indoor air inlet 110 and the indoor air outlet 120. The indoor heat exchanger 301 is arranged in the indoor air duct and is located between the indoor air inlet 110 and the indoor air outlet 120. The indoor heat exchanger 301 is fixedly connected to the chassis 100. The inner fan 340 includes an inner motor 341 and a cross-flow impeller 342. The cross-flow impeller 342 is arranged in the indoor air duct. The inner motor 341 is configured to drive the cross-flow impeller 342 to rotate to cause indoor air to flow through the indoor air duct, such that the indoor air passes through the indoor heat exchanger 301 for heat exchange.

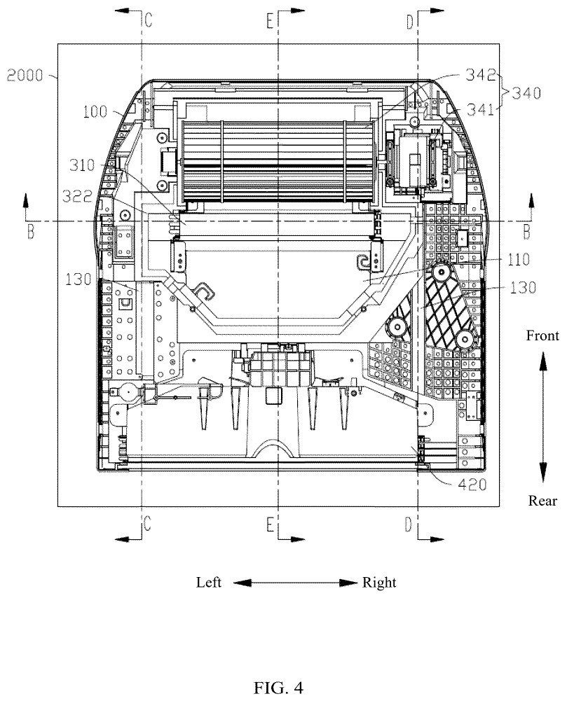

It should be noted that, referring to an embodiment show in FIG. 3, the indoor air duct is formed in the air duct component 320, such that the indoor air duct is separated from the outdoor air duct, to prevent communication between outdoor air and indoor air. The air duct component 320 may be made of a thermal insulation material. For example, the upper component 321 and the lower component 322 are made of a foam material, which has a thermal insulation effect. A drain pan 350 is formed at a middle portion of the lower component 322. The indoor heat exchanger 301 is arranged on the drain pan 350. The indoor air inlet 110 and the indoor air outlet 120 are respectively located on a front side and a rear side of the drain pan 350. Referring to FIG. 4, left and right side walls of the lower component 322 constitute left and right side walls of the drain pan 350 accordingly.

Continuing with reference to FIG. 2 and FIG. 3, it may be understood that the outer air duct assembly 400 includes an outdoor heat exchanger 401 and an outer air duct fixation member 420. The outdoor heat exchanger 401 is fixed to a position on the rear side of the chassis 100. The outer air duct fixation member 420 is fixedly connected to the chassis 100. The outer air duct fixation member 420 is arranged on a front side of the outdoor heat exchanger 401. The outer air duct fixation member 420 supports the outdoor heat exchanger 401. The outer air duct fixation member 420 may also be understood as an external air duct bracket. An air supply channel is formed between the outer air duct fixation member 420 and the outdoor heat exchanger 401. The air supply channel is in communication with the air inlet channel to form an outdoor air duct. The outer fan 430 is mounted on the outer air duct fixation member 420. Under the action of the outer fan 430, outdoor air may flow through the outdoor air inlet, the outdoor air duct, the outdoor heat exchanger 401, and the outdoor air outlet in sequence, such that the outdoor air passes through the outdoor heat exchanger 401 for heat exchange.

Referring to FIG. 2 and FIG. 3, it may be understood that there is a pipeline layout structure around the compressor 600. The compressor 600 is connected to the indoor heat exchanger 301 and the outdoor heat exchanger 401 through the pipeline layout structure to form a circulation loop, thereby forming an entire refrigeration system. In the refrigeration system, the indoor heat exchanger 301 serves as an evaporator 310 and the outdoor heat exchanger 401 serves as a condenser 410. The following embodiments are described using the evaporator 310 and the condenser 410 as an example.

It may be understood that the roof-mounted air conditioner 1000 of the embodiments is mainly designed for use in a large trailer which has large indoor space and requires a high cooling capacity. The evaporator 310 generates a large amount of condensed water during operation. Therefore, the roof-mounted air conditioner 1000 needs to make full use of the condensed water and address protection issues regarding drainage and guide of the condensed water in the roof-mounted air conditioner 1000. In addition, considering that the recreational vehicle faces harsh operating environments during traveling, such as large inclination angle of the recreational vehicle when driving uphill and downhill, it is necessary to ensure that the drainage channel may quickly guide and discharge the condensed water to the outside of the roof-mounted air conditioner 1000, and ensure that no condensed water will enter the recreational vehicle through the mounting opening 2100 on the roof of the recreational vehicle.

Referring to FIG. 3 and FIG. 4, it may be understood that the rear portion of the chassis 100 is provided with a water collection groove 140, and the outer fan 430 is located above the water collection groove 140 and arranged adjacent to the outdoor heat exchanger 401. The left and right side walls of the drain pan 350 are respectively provided with a water outlet 351. The water outlets 351 at the left and right side walls are formed on the side walls of the lower component 322. The chassis 100 is provided with two first drainage grooves 130. The two first drainage grooves 130 are respectively located on both sides of the indoor air inlet 110. The first drainage groove 130 on the left side is located below the water outlet 351 on the left side. The first drainage groove 130 on the right side is located below the water outlet 351 on the right side. The two first drainage grooves 130 are respectively in communication with the water collection groove 140 to form a drainage channel. Condensed water collected by the drain pan 350 is respectively discharged to the first drainage grooves 130 through the water outlets 351 on the left and right side walls, and then flows into the water collection groove 140 along the first drainage grooves 130. In this way, condensed water generated by the evaporator 310 may be collected by the water collection groove 140.

It should be noted that the number of the first drainage grooves 130 is not limited to two. For example, one first drainage groove 130 may be provided and arranged either on the left or on right side of the indoor air inlet 110, and the drain pan 350 is provided with one water outlet 351, which may be arranged according to the position of the first drainage groove 130. In addition, because the water outlets 351 are provided on two sides of an end portion of the drain pan 350, the water outlets 351 neither affect nor are affected by the intake air from the indoor air inlet 110, thereby improving the air intake efficiency.

Referring to FIG. 3, the outer fan 430 in an embodiment includes an impeller 432 and an outer motor 431. The outer motor 431 is fixedly mounted on the outer air duct fixation member 420, and the outer motor 431 is configured to drive the impeller 432 to rotate to cause outdoor air to exchange heat with the condenser 410. The impeller 432 is located above the water collection groove 140 and is arranged adjacent to the condenser 410. The impeller 432 makes contact with the condensed water in the water collection groove 140 when rotating, that is, the condensed water may be splashed and blown to the surface of the condenser 410, so as to further assist in heat dissipation of the condenser 410, thereby making full use of the condensed water and improving the heat exchange efficiency.

Considering that the drainage channel is distributed on an upper surface of the chassis 100, a back portion of the drainage channel may be cooled and thus condensed water may be generated when draining water. Consequently, the condensed water may enter the recreational vehicle through the mounting opening 2100 on the roof 2000 of the recreational vehicle, resulting in water leakage into the recreational vehicle room.

In view of the above, in the embodiments of the present disclosure, the design of the drainage channel is optimized, such that when the roof-mounted air conditioner 1000 is mounted on the roof 2000 of the recreational vehicle, a projection of the first drainage groove 130 and a projection of the water collection groove 140 on a projection plane perpendicular to the chassis 100 are respectively arranged spaced apart from a projection of the mounting opening 2100 of the recreational vehicle on the projection plane. As such, the drainage channel may avoid an area on the chassis 100 which corresponds to the mounting opening 2100 in a vertical direction.

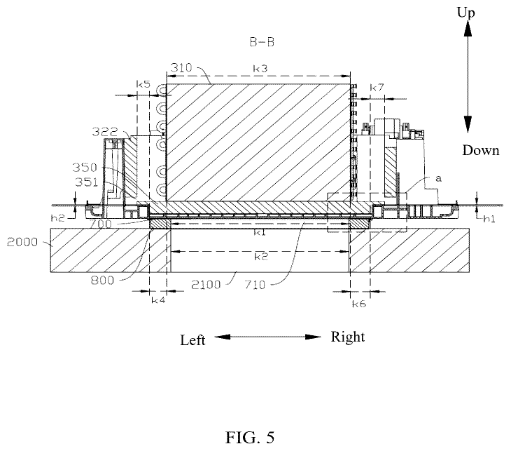

Specifically, in combination with FIG. 3, using a plane where the roof 2000 of the recreational vehicle lies as the projection plane, the projection of the water collection groove 140 does not overlap with the projection of the mounting opening 2100, and a back portion of the water collection groove 140 on the chassis 100 does not face the mounting opening 2100. Referring to FIG. 5, the projections of the two first drainage grooves 130 do not overlap with the projection of the mounting opening 2100, and the projections of the two first drainage grooves 130 are respectively located on the left and right sides of the projection of the mounting opening 2100, such that back portions of the first drainage grooves 130 on the chassis 100 do not face the mounting opening 2100. In this way, the back portion of the drainage channel does not face the mounting opening 2100 when draining and collecting condensed water, effectively avoiding the condensed water generated on the back portion due to the drainage channel get cooled from dripping into the recreational vehicle through the mounting opening 2100, thereby effectively solving the problem of condensed water entering the recreational vehicle through the mounting opening 2100, and improving user experience. The back portion of the first drainage groove 130 and the water collection groove 140 are understood as the areas corresponding to the first drainage groove 130 and the water collection groove 140 on a bottom surface of the chassis 100.

It should be noted that, referring to FIG. 3, the drain pan 350 is located above the mounting opening 2100, and the drain pan 350 forms a part of the lower component 322. The lower component 322 is made of a foam material, which has a certain thickness and provides a thermal insulation function. With the arrangement of the drain pan 350 to receive the condensed water generated by the evaporator 310, the condensed water may be isolated from the chassis 100. In this way, no condensed water will be formed in an area of the bottom of the drain pan 350 close to the chassis 100, and therefore, no condensed water will enter the recreational vehicle through the mounting opening 2100.

Referring to FIG. 4 and FIG. 5, the drainage channel further includes two second drainage grooves 150. The two second drainage grooves 150 are arranged on the chassis 100 and are respectively located on the left and right sides of the indoor air inlet 110. For example, the second drainage groove 150 on the left side is provided on a side of the first drainage groove 130 on the left side close to the mounting opening 2100. The second drainage groove 150 on the right side is provided on a side of the first drainage groove 130 on the right side close to the mounting opening 2100. A bottom of each of the second drainage grooves 150 on the left and right sides is provided with a drainage hole 153. The drainage holes 153 run through the bottom surface of the chassis 100, such that water entering the second drainage grooves 150 may be discharged out of the roof-mounted air conditioner 1000.

It may be understood that when the roof-mounted air conditioner 1000 is mounted on the roof 2000 of the recreational vehicle, the projections of the first drainage grooves 130 and the second drainage grooves 150 are arranged spaced apart from the projection of the mounting opening 2100, that is, projections of the drainage holes 153 do not overlap with the projection of the mounting opening 2100 on the projection plane, such that water discharged from the drainage holes 153 does not enter the mounting opening 2100. It should be noted that the number of the second drainage grooves 150 is determined according to the number of the first drainage grooves 130, which is not limited herein.

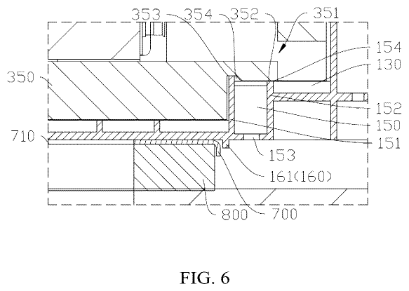

Referring to FIG. 5 and FIG. 6, using the first drainage groove 130 and the second drainage groove 150 on the right side as an example, the first drainage groove 130 is located below the water outlet 351 of the drain pan 350, the second drainage groove 150 is located on the left side of the first drainage groove 130, and condensed water discharged from the water outlet 351 may enter the first drainage groove 130 and flow to the water collection groove 140 along the first drainage groove 130. It may be understood that when the amount of condensed water in the first drainage groove 130 is too much or when the recreational vehicle bumps during traveling, water in the first drainage groove 130 may overflow and enter the second drainage groove 150, and the water may be discharged out of the roof-mounted air conditioner 1000 through the drainage hole 153. The position of the drainage hole 153 is arranged to avoid the area where the mounting opening 2100 is located, thereby preventing the overflowing condensed water from entering the recreational vehicle room along the mounting opening 2100, and further reducing the risk of water leakage in the recreational vehicle at the mounting opening 2100.

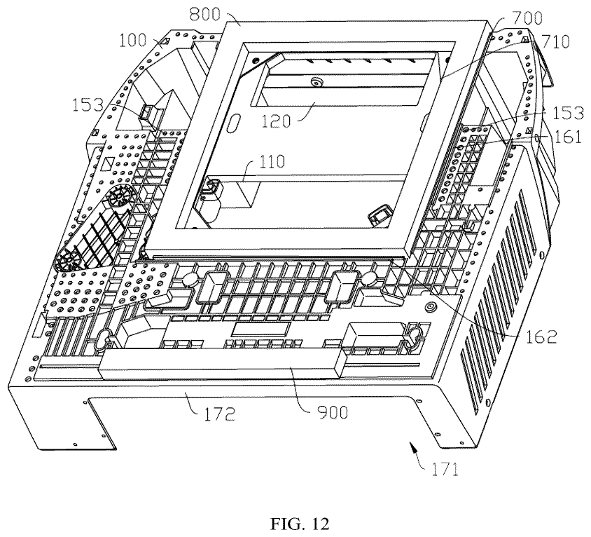

It should be noted that since the support plate 700 is arranged at the bottom of the chassis 100 and the second drainage groove 150 is located between the first drainage groove 130 and the support plate 700, the drainage hole 153 is arranged outside the area where the support plate 700 is mounted. Referring to FIG. 6 and FIG. 12, in a preferred embodiment, the drainage hole 153 is arranged close to an edge of the support plate 700, and is sealed by the sealing ring 800 to prevent the discharged condensed water from passing through the support plate 700 and entering the mounting opening 2100. In addition, a plurality of drainage holes 153 may be provided. The plurality of drainage holes 153 are distributed in a length direction of the second drainage groove 150, such that condensed water that overflows may be quickly drained, thereby the drainage efficiency is improved.

Referring to FIG. 5 and FIG. 6, in an embodiment, a side wall of the second drainage groove 150 close to the indoor air inlet 110 is a first side wall 151, and a side wall of the second drainage groove 150 away from the indoor air inlet 110 is a second side wall 152. It may be understood that FIG. 6 shows relative positions of the second drainage groove 150 and the first drainage groove 130 on the right side. Condensed water in the first drainage groove 130 may overflow from the second side wall 152 to enter the second drainage groove 150. To prevent condensed water from further overflowing from the first side wall 151, a height of the first side wall 151 is set to be greater than a height of the second side wall 152, and a difference h1 between the height of the first side wall 151 and the height of the second side wall 152 is greater than or equal to 1 mm, i.e., the first side wall 151 needs to be at least 1 mm higher than the second side wall 152. It should be noted that referring to FIG. 5, a difference h2 between heights of the two side walls of the second drainage groove 150 on the left side is also greater than or equal to 1 mm. The values of h1 and h2 may be the same or different, which is not limited herein.

Referring to FIG. 5 and FIG. 6, the water outlet 351 of the drain pan 350 is located at a bottom of the side wall of the lower component 322, an end portion of the drain pan 350 covers the second drainage groove 150, a surface of the end portion facing the second drainage groove 150 is a first end face 352, a groove 354 is formed at an end of the first end face 352 away from the first drainage groove 130, and a bottom wall of the groove 354 is a second end face 353. The first end face 352 and the second end face 353 are at different height levels, and the first end face 352 is closer to the second drainage groove 150 than the second end face 353. The second end face 353 abuts against the first side wall 151. The first end face 352 is spaced apart from the second side wall 152. An overflow gap 155 is formed between the first end face 352 and the second side wall 152, such that condensed water in the first drainage groove 130 may overflow from the overflow gap 155 to the second drainage groove 150. A width of the overflow gap 155 may be greater than or equal to 1 mm, which is not particularly limited in the embodiments.

When the recreational vehicle suddenly goes downhill or brakes during traveling, the front portion of the roof-mounted air conditioner 1000 tilt down greatly, and water in the water collection groove 140 at the rear portion of the roof-mounted air conditioner 1000 quickly flows forward into the first drainage grooves 130 on the left and right sides. To solve this problem, the structure of the drainage channel in the above embodiment is adopted to ensure that when a large amount of condensed water suddenly flows into the first drainage groove 130, the excessive condensed water may overflow over the first drainage groove 130 to enter the second drainage groove 150 and be quickly discharged out of the area where the mounting opening 2100 is located.

Referring to FIG. 6, a top of the first side wall 151 supports a bottom surface of the drain pan 350 to form a tight contact fit. Since the drain pan 350 is made of a foam material, the foam material is easily compressed when it abuts against the first side wall 151 to achieve an interference fit. In this way, a desirable sealed structure is formed to prevent an excessive amount of water from suddenly flowing into the second drainage groove 150 and overflowing to the area close to an inner side of the mounting opening 2100, thereby effectively preventing water leakage at the mounting opening 2100.

Referring to FIG. 5, when the roof-mounted air conditioner 1000 is mounted on the roof 2000 of the recreational vehicle, the sealing ring 800 is arranged surrounding the mounting opening 2100. The roof-mounted air conditioner 1000 is mounted at a top of the support plate 700. In the left-right direction of the chassis 100, a width of the opening 710 of the support plate 700 is k1, a width of the mounting opening 2100 is k2, a width of the evaporator 310 is k3, a distance between a left end portion of the evaporator 310 and a left edge of the support plate 700 is k4, a distance between the left edge of the support plate 700 and the water outlet 351 on the left side is k5, a distance between a right end portion of the evaporator 310 and a right edge of the support plate 700 is k6, and a distance between the right edge of the support plate 700 and the water outlet 351 on the right side is k7. The width k2 of the mounting opening 2100 is less than or equal to the width k1 of the opening 710. A sum of k4, k3, and k6 is greater than k1. A width of the drain pan 350 equals a sum of k5, k4, k6, k7, and k3, such that the width of the drain pan 350 is greater than a width of the support plate 700, and the second drainage groove 150 may be located between the water outlet 351 of the drain pan 350 and the support plate 700. As such, the back portion of the drainage channel may be separated from the area where the support plate 700 is mounted.

Referring to FIG. 6, a sum of k5 and k4 is a distance between the left side wall of the drain pan 350 and the left end of the evaporator 310, and is greater than or equal to 20 mm. A sum of k6 and k7 is a distance between the right side wall of the drain pan 350 and the right end of the evaporator 310, and is greater than or equal to 30 mm. In other words, the distance between the left end of the evaporator 310 and the left water outlet 351 of the drain pan 350 may be the same as or different from the distance between the right end of the evaporator 310 and the right water outlet 351 of the drain pan 350. Considering that the inlet and outlet pipelines of the evaporator 310 are arranged on the right side of the evaporator 310, the sum of k6 and k7 may be greater than the sum of k5 and k4, which is more reasonable in design.

Referring to FIG. 5 and FIG. 6, in an embodiment, stop ribs 160 are arranged at the bottom of the chassis 100. The stop ribs 160 include first stop ribs 161 located on left and right sides of the support plate 700 and second stop ribs 162 located on front and rear sides of the support plate 700. It may be understood from FIG. 12 that the first stop ribs 161 are configured to limit the left and right positions of the support plate 700, and the second stop ribs 162 are configured to limit the front and rear positions of the support plate 700. It should be noted that each first stop rib 161 is located between the corresponding drainage hole 153 and the support plate 700, and the first stop ribs 161 not only provide a function of limiting the support plate 700, but also can block condensed water discharged from the drainage hole 153, to prevent the condensed water from spreading laterally along a periphery of the drainage hole 153 and entering the top of the support plate 700 due to the capillary action of water on the surface of the chassis 100 and then spreading to the indoor air inlet 110 and the indoor air outlet 120 and entering the recreational vehicle due to the capillary action. In other words, the first stop ribs 161 have positioning and waterproofing functions.

It should be noted that using the first stop rib 161 on the right side as an example, in the left-right direction of the chassis 100, the second drainage groove 150 is located between the support plate 700 and the water outlet 351, i.e., between k5 and k7, and the first stop rib 161 is close to the edge of the support plate 700, to effectively prevent the discharged condensed water from entering the mounting opening 2100.

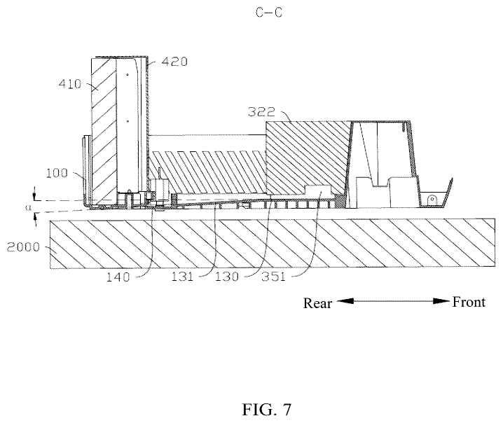

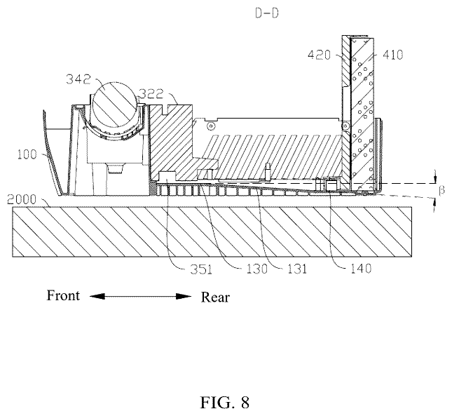

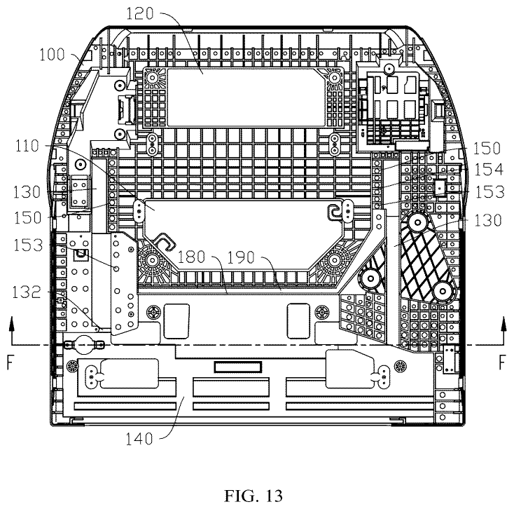

Referring to FIG. 7 and FIG. 8, a bottom wall of a front section of each of the first drainage grooves 130 on the left and right sides is a flat surface, and is located below the corresponding water outlet 351 to receive the discharged condensed water. A rear section of each of the first drainage grooves 130 obliquely extends from front to rear to form an inclined surface 131. Condensed water in the first drainage groove 130 is discharged to the water collection groove 140 across the inclined surface 131. As such, the condensed water may be quickly discharged to the rear portion of the chassis 100, thereby preventing the accumulation of the condensed water at the front section of the first drainage groove 130. An angle between the inclined surface 131 of the first drainage groove 130 on the left side and a horizontal plane is a. An angle between the inclined surface 131 of the first drainage groove 130 on the right side and the horizontal plane is. Values of a and B are greater than or equal to 1°, i.e., inclination angles of the inclined surfaces 131 need to be greater than or equal to 1°. The inclination angles of the inclined surfaces 131 on the two sides may be the same or different. Referring to FIG. 13, a back portion of each of the inclined surfaces 131 on the two sides is located outside the area where the support plate 700 is mounted, to prevent condensed water generated due to cold energy received on the back portion of the inclined surface 131 from entering the mounting opening 2100.

Referring to FIG. 13, in some embodiments, a narrowed opening is provided at an end of the inclined surface 131 of the first drainage groove 130. A width of the narrowed opening is less than a width of the first drainage groove 130, the first drainage groove 130 is in communication with the water collection groove 140 through the narrowed opening, and the width of the first drainage groove 130 is narrowed at the position of communication. In some other embodiments, a width of a part of the first drainage groove 130 close to the water collection groove 140 gradually decreases, i.e., the first drainage groove 130 may gradually shrink, to narrow a channel through which condensed water flows back from the water collection groove 140 along the first drainage groove 130, thereby reducing the amount of water flowing back, alleviating the drainage burden of the second drainage groove 150, and reducing the risk of condensed water entering the area corresponding to the mounting opening 2100.

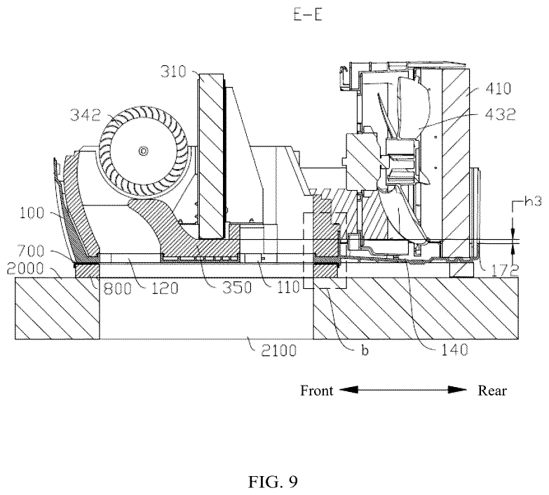

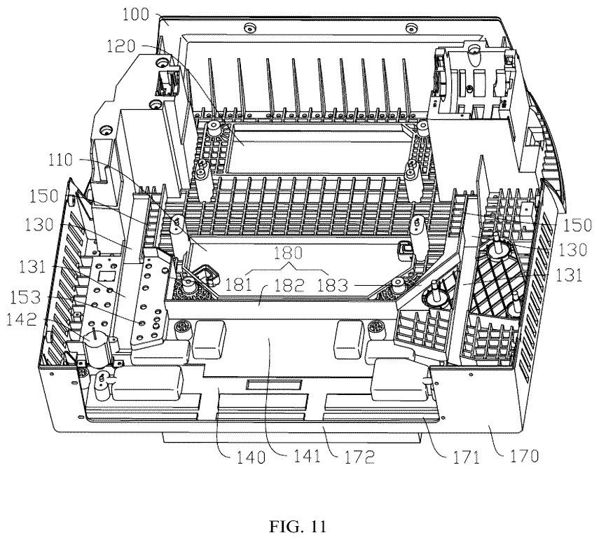

Referring to FIG. 9 and FIG. 11, a rear side edge of the chassis 100 is provided with a rear plate 170. The rear plate 170 is provided with a notch 171, and a bottom of the rear plate 170 forms a rear baffle wall 172 of the water collection groove 140 at the notch 171. It may be understood that the water collection groove 140 is defined and enclosed by the chassis 100 and the baffle walls in different directions. The rear baffle wall 172 has a small height, such that when a large amount of condensed water has been collected in the water collection groove 140, the condensed water may overflow along the rear baffle wall 172 and thus be discharged out of the roof-mounted air conditioner 1000.

Referring to FIG. 3, in an embodiment, the bottom surface of the drain pan 350 is higher than the rear baffle wall 172 by a height difference h3. The value of h3 is greater than or equal to 1 mm, such that condensed water collected on the drain pan 350 may be discharged backward into the water collection groove 140 in time. With the setting of the height difference, even if the water collection groove 140 is filled up with condensed water, the condensed water will overflow from the rear baffle wall 172 and be discharged, and no condensed water will accumulate in the drain pan 350.

In addition, it may be understood that in an embodiment, the top of the first side wall 151 of each of the second drainage grooves 150 is at a height higher than a top of the rear baffle wall 172, with a height difference of greater than or equal to 1 mm. With such an arrangement, even if the roof-mounted air conditioner 1000 operates for a long time when the recreational vehicle is parked and kept stationary on a flat road and the water collection groove 140 at the rear portion of the roof-mounted air conditioner 1000 is filled up with condensed water, the condensed water will overflow from a rear edge of the roof-mounted air conditioner 1000, or the condensed water will overflow from the first drainage groove 130 to the second drainage groove 150 and be discharged out of the roof-mounted air conditioner 1000, to ensure that the condensed water will not further overflow from the first side wall 151 and enter the area corresponding to the mounting opening 2100. As such, double protection is provided to effectively solve the problem of condensed water entering the mounting opening 2100 and dripping into the recreational vehicle. Certainly, the need to prevent water leakage when a large amount of condensed water pours from rear to front during tilting may also be better met.

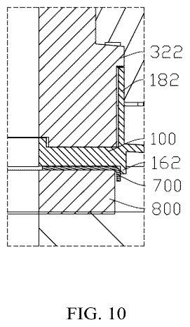

Referring to FIG. 9 and FIG. 10, it should be noted that the chassis 100 is provided with a second stop rib 162 at a rear edge of the support plate 700 to limit the position of the support plate 700 in the front-rear direction when mounted on the chassis 100. A back portion of the second stop rib 162 is a front baffle wall 180 which extends upward from the chassis 100. Referring to FIG. 9, a height of the front baffle wall 180 is greater than that of the rear baffle wall 172, and a top of the front baffle wall 180 is covered by the foam material of the lower component 322 to form a sealed structure. With such an arrangement, the condensed water splashed by the impeller 432 to the air intake grille 210 or rainwater that enters the air intake grille 210 may be prevented from entering the gap between the front baffle wall 180 and the foam material, thus preventing the condensed water or rainwater from leaking into the indoor air inlet 110 along the chassis 100 and dripping into the recreational vehicle through the mounting opening 2100.

Referring to FIG. 9, an inclined guide surface 141 is provided between the front baffle wall 180 and the rear baffle wall 172. Referring to FIG. 11, a front side of the front baffle wall 180 is an area where the inner air duct assembly 300 is mounted. The area where the inner air duct assembly 300 is mounted substantially corresponds to the area where the support plate 700 is mounted. The inclined guide surface 141 is located at a rear side of the front baffle wall 180. The arrangement of the inclined guide surface 141 allows condensed water splashed by the impeller 432 to flow back toward the rear portion. An inclination angle of the inclined guide surface 141 may be set to be greater than or equal to 1°.

The drainage channel on the chassis 100 is further illustrated in detail with reference to FIG. 11 and FIG. 12. FIG. 11 is an overall schematic structural view of the chassis 100. FIG. 12 is a view showing the support plate 700 and the sealing ring 800 assembled on the chassis 100. It may be understood that the front baffle wall 180 is higher than the baffle walls of the water collection groove 140 at other positions. The front baffle wall 180 includes a front left baffle wall 181, a front middle baffle wall 182, and a front right baffle wall 183. The arrangement of the baffle walls on the front side of the water collection groove 140 may block a large amount of condensed water, to prevent the condensed water from entering the area where the inner air duct assembly 300 is mounted, thereby preventing water leakage into the recreational vehicle.

It should be noted that, as shown in FIG. 11 and FIG. 12, the drainage hole 153 may not only be limited to being provided in the second drainage groove 150. In addition to the first drainage groove 130 that needs to guide and drain condensed water, the water collection groove 140 that stores water, and the area above the support plate 700, the drainage hole 153 may also be provided in other areas on the chassis 100 according to actual application requirements. For example, the drainage hole 153 is provided close to the front left baffle wall 181, such that when the roof-mounted air conditioner 1000 tilts forward along with the forward tilting of the recreational vehicle, a large amount of condensed water that flows forward may be quickly diverted through the drainage hole 153 close to the front left baffle wall 181, and then discharged out of the chassis 100.

Referring to FIG. 13, it is a schematic structural front view of the chassis 100. A front end of each of the second drainage grooves 150 on two sides is provided with a bent section. The bent section extends and surrounds a front side of the first drainage groove 130, such that the second drainage groove 150 is substantially L-shaped and partially surrounds the first drainage groove 130. In addition, a plurality of drainage holes 153 are provided at the bottom of the second drainage groove 150, such that condensed water that overflows into the second drainage groove 150 may be discharged out of the chassis 100 in time. A protrusion rib 154 is provided between adjacent drainage holes 153, to reinforce the structure of the chassis 100.

It should be noted that in an embodiment, the first side wall 151 of the second drainage groove 150 is higher than the second side wall 152, the first side wall 151 is fitted to the bottom surface of the drain pan 350 to form a sealed structure, and the second drainage groove 150 partially surrounds the front portion of the first drainage groove 130. With such an arrangement, the water collection groove 140 in the roof-mounted air conditioner 1000 is enabled to be filled up with condensed water. When the recreational vehicle suddenly goes downhill or brakes such that the roof-mounted air conditioner 1000 tilts forward, a large amount of condensed water in the water collection groove 140 that suddenly flows forward may be quickly discharged through the second drainage groove 150, to prevent the condensed water from entering the area where the inner air duct assembly 300 is mounted.

Referring to FIG. 13, in some embodiments, the chassis 100 is further provided with a third drainage groove 190. The third drainage groove 190 is located on a side of the front baffle wall 180 close to the indoor air inlet 110, and the third drainage groove 190 extends along the front baffle wall 180 and is in communication with the second drainage groove 150. The third drainage groove 190 is located in an area where the lower component 322 is mounted, and extends to the second drainage groove 150 along an edge of the area. In an embodiment, as shown in FIG. 13, the third drainage groove 190 is in communication with the second drainage groove 150 on the right side. In some other embodiments, the third drainage groove 190 may also be in communication with the second drainage groove 150 on the left side, or in communication with the second drainage grooves 150 on both sides. Considering that condensed water in the water collection groove 140 may overflow forward from the front baffle wall 180 in an extreme situation when the vehicle is traveling, the arrangement of the third drainage groove 190 may guide the condensed water that overflows to the second drainage groove 150, to prevent the condensed water from further entering the indoor air inlet 110.

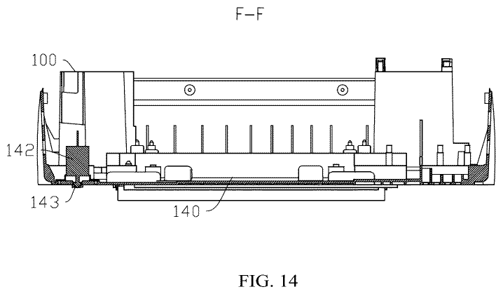

Referring to FIG. 14, in some embodiments, a temperature-controlled drain valve 142 is arranged in the water collection groove 140, and the chassis 100 is provided with a temperature-controlled drain port 143 connected to the temperature-controlled drain valve 142. The temperature-controlled drain valve 142 is configured to block the temperature-controlled drain port 143 on the chassis 100 at room temperature, and automatically open the temperature-controlled drain port 143 in cold weather to help realize quick drainage. Such a design is applicable to a roof-mounted air conditioner 1000 that may provide both cooling and heating, and is especially suitable for use in winter to meet the need for defrosting and rapid water drainage.

An embodiment of the present disclosure provides a vehicle, including the roof-mounted air conditioner 1000 of any one of the above embodiments. The vehicle is, for example, a recreational vehicle. Using a recreational vehicle as an example, the roof-mounted air conditioner 1000 is mounted on a roof 2000 of the recreational vehicle, and both the indoor air inlet 110 and the indoor air outlet 120 are in communication with a mounting opening 2100 on the roof 2000, to realize air circulation at indoor side. Outside the roof-mounted air conditioner 1000, air flows in from left and right sides and flows out from the rear side, thus forming airflow at outdoor side. In this way, the back portion of the drainage channel does not face the mounting opening 2100 during drainage and collection of condensed water, condensed water generated due to cold energy received on the back portion of the drainage channel may be effectively prevented from dripping into the recreational vehicle through the mounting opening 2100, thereby improving user experience.

Because the vehicle adopts all the technical schemes of the roof-mounted air conditioner 1000 of the above embodiments, the motor has at least all the beneficial effects achieved by the technical schemes of the above embodiments, and the details will not be repeated here.

The embodiments of the present disclosure have been described in detail above with reference to the accompanying drawings, but the present disclosure is not limited to the above embodiments, and various changes may be made within the knowledge of those having ordinary skills in the art without departing from the protection scope of the present disclosure.

1-19. (canceled)

20. A roof-mounted air conditioner comprising:
a chassis, a front portion of the chassis being provided with an indoor air inlet and an indoor air outlet, and a rear portion of the chassis being provided with a water collection groove;
an indoor heat exchanger, fixedly connected to the chassis and located between the indoor air inlet and the indoor air outlet; and
a drain pan, arranged between the chassis and a bottom of the indoor heat exchanger;
wherein a drainage groove is arranged on the chassis, and the drainage groove is in communication with the drain pan and the water collection groove.

21. The roof-mounted air conditioner of claim 20, wherein when the roof-mounted air conditioner is mounted at a mounting opening on a roof of a vehicle, a projection of the drainage groove and a projection of the water collection groove on a projection plane perpendicular to the chassis are arranged spaced apart from a projection of the mounting opening of the vehicle on the projection plane.

22. The roof-mounted air conditioner of claim 20, wherein:
the drainage groove is a first drainage groove; and
the chassis is further provided with a second drainage groove in communication with the first drainage groove, the second drainage groove is located on a side of the first drainage groove adjacent to the indoor air inlet, and a drainage hole is provided at a bottom of the second drainage groove.

23. The roof-mounted air conditioner of claim 22, wherein when the roof-mounted air conditioner is mounted at a mounting opening on a roof of a vehicle, a projection of the second drainage groove on a projection plane perpendicular to the chassis is arranged spaced apart from a projection of the mounting opening of the vehicle on the projection plane.

24. The roof-mounted air conditioner of claim 22, wherein the drainage hole is one of a plurality of drainage holes are distributed at intervals in a length direction of the second drainage groove, and a protrusion rib is provided between two adjacent ones of the plurality of drainage holes.

25. The roof-mounted air conditioner of claim 22, wherein a height of a first side wall of the second drainage groove close to the indoor air inlet is greater than a height of a second side wall of the second drainage groove away from the indoor air inlet, and a difference between the height of the first side wall and the height of the second side wall is greater than or equal to 1 mm.

26. The roof-mounted air conditioner of claim 22, wherein an end portion of the drain pan extends toward the first drainage groove in a width direction of the chassis and covers an upper surface of the second drainage groove, a first end face of the end portion faces the second drainage groove, a second end face is recessed at an end of the first end face away from the first drainage groove, the second end face abuts against the first side wall, and an overflow gap is formed between the first end face and the second side wall.

27. The roof-mounted air conditioner of claim 22, wherein in a length direction of the chassis, a front end of the second drainage groove is provided with a bent section extending forward to a front side of the first drainage groove.

28. The roof-mounted air conditioner of claim 22, wherein a rear side edge of the chassis is provided with a rear plate, the rear plate is provided with a notch, a bottom of the rear plate forms a rear baffle wall of the water collection groove at the notch, and a top of a side wall of the second drainage groove close to the indoor air inlet is at a height higher than a top of the rear baffle wall.

29. The roof-mounted air conditioner of claim 28, wherein a front side edge of the water collection groove is provided with a front baffle wall, and the front baffle wall is at a height higher than the rear baffle wall.

30. The roof-mounted air conditioner of claim 29, wherein the chassis is provided with a third drainage groove arranged on a side of the front baffle wall close to the indoor air inlet, and the third drainage groove extends along the front baffle wall and is in communication with the second drainage groove.

31. The roof-mounted air conditioner of claim 22, wherein a support plate, a sealing ring, and a stop rib configured to position the support plate are arranged at a bottom of the chassis, the stop rib is at least arranged between the drainage hole and the support plate, a width of the drain pan is greater than a width of the support plate, the support plate is provided with an opening, and the opening is in communication with the mounting opening of the vehicle when the roof-mounted air conditioner is mounted on the roof of the vehicle, and the sealing ring is located between the support plate and the roof of the vehicle.

32. The roof-mounted air conditioner of claim 31, wherein when the roof-mounted air conditioner is mounted at a mounting opening on a roof of a vehicle, a width of the opening is greater than or equal to a width of the mounting opening of the vehicle in a width direction of the chassis.

33. The roof-mounted air conditioner of claim 20, wherein a distance between a left side wall of the drain pan and a left end of the indoor heat exchanger is greater than or equal to 20 mm, and a distance between a right side wall of the drain pan and a right end of the indoor heat exchanger is greater than or equal to 30 mm.

34. The roof-mounted air conditioner of claim 20, wherein at least a portion of a bottom wall of the drainage groove obliquely extends downward from front to rear in a length direction of the chassis to the water collection groove.

35. The roof-mounted air conditioner of claim 20, wherein an end of the drainage groove in communication with the water collection groove is provided with a narrowed opening, and a width of the narrowed opening is less than a width of the drainage groove.

36. The roof-mounted air conditioner of claim 20, further comprising:
an air duct component made of a thermal insulation material;
wherein an indoor air duct in communication with the indoor air inlet and the indoor air outlet is formed in the air duct component, the indoor heat exchanger is arranged in the indoor air duct, and the drain pan is formed at a bottom of the air duct component.

37. The roof-mounted air conditioner of claim 20, further comprising:
an outdoor heat exchanger, fixedly connected to the rear portion of the chassis; and
an outer fan, including an impeller and an outer motor configured to drive the impeller to rotate, the impeller being located above the water collection groove, and the impeller being configured to rotate and sling water in the water collection groove onto the outdoor heat exchanger.

38. A vehicle comprising:
a roof, a mounting opening being provided on the roof; and
a roof-mounted air conditioner mounted at the mounting opening and including:
a chassis, a front portion of the chassis being provided with an indoor air inlet and an indoor air outlet, and a rear portion of the chassis being provided with a water collection groove;
an indoor heat exchanger, fixedly connected to the chassis and located between the indoor air inlet and the indoor air outlet; and
a drain pan, arranged between the chassis and a bottom of the indoor heat exchanger;
wherein a drainage groove is arranged on the chassis, and the drainage groove is in communication with the drain pan and the water collection groove.
